(19) United States
(12) Patent Application Publication
(10) Pub. No.: US 2020/0271930 A1
(43) Pub. Date: Aug. 27, 2020

(54) DRIVE DEVICE AND DRIVE DEVICE USED IN HEAD-UP DISPLAY DEVICE

(71) Applicant: NIDEC SANKYO CORPORATION, NAGANO (JP)

(72) Inventors: Hiroyuki HATASAKO, NAGANO (JP); Takanori OHKAWA, NAGANO (JP); Takafumi KASUGA, NAGANO (JP); Takahisa UEKI, NAGANO (JP)

(73) Assignee: NIDEC SANKYO CORPORATION, NAGANO (JP)

(21) Appl. No.: 16/647,019

(22) PCT Filed: Jul. 23, 2018
(86) PCT No.: PCT/JP2018/027514

§ 371 Date: Mar. 13, 2020

(30) Foreign Application Priority Data
Sep. 15, 2017 (JP) 2017-177352

(51) Int. Cl. G02B 27/01; F16H 25/24

(52) U.S. Cl. CPC G02B 27/0149; F16H 25/24

(57) ABSTRACT

A drive device includes a drive unit, a lead screw rotationally driven by the drive unit, and a movable member being moved by a driving force of the drive unit. The movable member includes a main body unit, a driving force transmitting unit configured to transmit a driving force of the drive unit to the main body unit, and preload applying units provided separately from the main body unit. The driving force transmitting unit includes a first thread unit to be screwed together with the lead screw and moves the main body unit in an axis direction of the lead screw with a rotation of the lead screw, and the preload applying units include a second thread unit to be screwed together with the lead screw and apply a preload between the first thread unit and the second thread unit.

### TECHNICAL FIELD

The present invention relates to a drive device for moving a movable member by a driving force of a drive unit.

### BACKGROUND ART

Conventionally, there is known a head-up display device in which display light from a display element is reflected by a reflecting member (concave mirror) and projected on a windshield of a vehicle, and a projected display image (virtual image) is visually recognized by a driver of the vehicle. Such a head-up display device typically includes a drive device in which a mirror holder holding a concave mirror is pivoted about a predetermined rotational axis to adjust a reflection angle of the display light by the reflecting member.

Patent Literatures 1 and 2 describe a drive device in which a driving force is transmitted to a protruding piece partially protruding radially outward of a rotational axis from a mirror holder to pivot the mirror holder. The drive device includes a stepping motor, a lead screw (feed screw) rotationally driven by the stepping motor, a guide shaft arranged in parallel with the lead screw, a frame configured to support the lead screw and the guide shaft, and a slider including a nut to be screwed together with the lead screw and being formed with a guide hole through which the guide shaft penetrates, the slider reciprocating along an axis direction of the lead screw with a rotation of the lead screw. The slider includes a support unit configured to support the protruding piece of the mirror holder being a supported member. As a result, it is possible to pivot the mirror holder when the slider configured to support the protruding piece of the mirror holder reciprocates.

### CITATION LIST

### Patent Literature

[Patent Literature 1] Japanese Unexamined Patent Application Publication No. 2015-102700

[Patent Literature 2] Japanese Unexamined Patent Application Publication No. 2016-109974

### SUMMARY OF THE INVENTION

### Problem to be Solved by the Invention

In the drive device described in Patent Literatures 1 and 2, the slider may rattle in the movement direction due to a clearance between the lead screw and the nut, and as a result, there is a possibility of rattling of the mirror holder causing a display image to be blurred.

Therefore, an object of the present invention is to provide a drive device that suppresses rattling of a movable member in a movement direction, and a drive device used in a head-up display device.

### Means for Solving the Problem

To solve the above-described problem, a drive device according to the present invention includes a drive unit, a lead screw rotationally driven by the drive unit, and a movable member being moved by a driving force of the drive unit. The movable member includes a main body unit, a driving force transmitting unit configured to transmit a driving force of the drive unit to the main body unit, and a preload applying unit provided separately from the main body unit, the driving force transmitting unit includes a first thread unit to be screwed together with the lead screw and moves the main body unit in an axis direction of the lead screw with a rotation of the lead screw, and the preload applying unit includes a second thread unit to be screwed together with the lead screw and applies a preload between the first thread unit and the second thread unit.

According to the drive device of the present invention, it is possible to absorb a clearance (backlash) between the lead screw and each of the thread units, and thus, and it is possible to suppress a rattling of the movable member in a movement direction (an axis direction of the lead screw).

According to one aspect of the present invention, preferably, the driving force transmitting unit includes a first thread unit, and includes a first nut member provided separately from the main body unit, the preload applying unit includes a second nut member including a second thread unit, and an urging member provided between the first nut member and the second nut member, a nut arrangement unit in which the first nut member and the second nut member are arranged is formed in the main body unit, and the first nut member and the second nut member are arranged in the nut arrangement unit in a state in which rotation with respect to the main body unit is restricted. In this case, preferably, a driving force receiving unit configured to receive a driving force of the drive unit from the first nut member is formed in the nut arrangement unit, and the first nut member is applied with a preload from the urging member via the driving receiving unit. As a result, it is possible to arrange both the first nut member and the second nut member in the main body unit and to save the space of the device.

Further, according to one aspect of the present invention, preferably, the urging member is a coil spring, the lead screw penetrates an inside of the coil spring, and the urging member is arranged between the driving force receiving unit and the second nut member. In this case, preferably, the first nut member includes a tubular unit on which the first thread unit is formed, and a flange unit, the flange unit abuts against the driving force receiving unit, and a restricting unit configured to restrict a rotation of the first nut member by abutting against the flange unit is provided in the nut arrangement unit, and preferably, the second nut member includes a tubular unit on which the second thread unit is formed, and a flange unit, and a restricting unit configured to restrict a rotation of the second nut member by abutting against the flange unit is provided in the nut arrangement unit. As a result, it is possible to more compactly configure the first nut member, the urging member, and the second nut member and to further save the space.

Further, preferably, the drive device according to the present invention includes a frame configured to rotatably support the lead screw, the frame includes a plate-shaped frame main body facing the main body unit, and the nut arrangement unit opens in a direction crossing a direction in which the main body unit and the frame main body face each other. As a result, when the first nut member and the second nut member are arranged in the nut arrangement unit, the frame (frame main body) is not an obstacle, and the workability can be improved.

Further, preferably, a guide shaft configured to guide the movement of the movable member is attached to the frame, the guide shaft is arranged in parallel with the lead screw, the movable member includes a support unit configured to support the supported member, and the support unit is provided on the opposite side of the guide shaft across the lead screw.

As a result, the movement of the movable member can be stabilized.

Further, preferably, the movable member includes a support unit configured to support the supported member, and the support unit includes an elastic support unit configured to urge the supported member, and a fixed support unit provided to face the elastic support unit in a movement direction of the movable member and configured to support the supported member urged by the elastic support unit. As a result, the supported member is held in a state of being pressed against the fixed support unit by the elastic support unit, which makes it possible to position the supported member with reference to the fixed support unit.

Preferably, the elastic support unit includes an elastic member configured to abut against the supported member to urge the supported member toward the fixed support unit, and an elastic member fixing unit configured to hold the elastic member, and the elastic member fixing unit is provided in the main body unit. In this case, the elastic member is preferably a leaf spring. As a result, it is possible to easily fix the elastic member.

Preferably, the elastic member includes a fixed plate unit attached to the elastic member fixing unit, and an elastically deformable plate unit extending from an end of the fixed plate unit and being elastically deformable, the elastically deformable plate unit includes a first elastic unit extending from an end of the fixed plate unit, and a second elastic unit extending from an end of the first elastic unit, and an abutment unit configured to abut against the supported member is formed in the second elastic unit. As a result, it is possible to secure the elasticity of the elastically deformable plate unit.

Further, preferably, the fixed support unit is formed of a material having higher rigidity than the main body unit, and is partially embedded in and fixed to the main body unit. As a result, it is possible to improve the strength of the support unit configured to support the supported member.

Further, preferably, the fixed support unit supports the supported member at a position facing the supported member in a movement direction of the movable member. In addition, preferably, the fixed support unit includes a support main body unit extending in a direction crossing the movement direction of the movable member, and an extending unit extending from an end of the support main body unit in a movement direction of the movable member, and at least a part of an upper surface of the extending unit is covered with the main body unit. As a result, it is possible to improve the pull-out strength of the fixed support unit from the main body unit.

To solve the above-described problem, a drive device used in a head-up display device according to the present invention includes a drive unit, a lead screw rotationally driven by the drive unit, and a movable member being moved by a driving force of the drive unit.

The movable member includes a main body unit, a driving force transmitting unit configured to transmit a driving force of the drive unit to the main body unit, a preload applying unit provided separately from the main body unit, and a support unit configured to pivotably support a mirror holder supporting a concave mirror, the driving force transmitting unit includes a first thread unit to be screwed together with the lead screw and moves the main body unit in an axis direction of the lead screw with a rotation of the lead screw, and the preload applying unit includes a second thread unit to be screwed together with the lead screw and applies a preload between the first thread unit and the second thread unit. Further, preferably, the concave mirror irradiates a windshield of a vehicle with display light. Further, preferably, the support unit includes an elastic support unit configured to urge the mirror holder, and a fixed support unit provided to face the elastic support unit in a movement direction of the movable member, and configured to support the mirror holder urged by the elastic support unit. Preferably, a first nut member provided separately from the main body unit is provided, and a second nut member including the second thread unit, and an urging member provided between the first nut member and the second nut member and configured to apply a preload between the first thread unit and the second thread unit are provided, and a nut arrangement unit in which the first nut member and the second nut member are arranged is formed in the main body unit. Preferably, the first nut member and the second nut member are arranged in the nut arrangement unit in a state where rotation with respect to the main body unit is restricted, a driving force receiving unit configured to receive a driving force of the drive unit from the first nut member is formed in the nut arrangement unit, and the first nut member is applied with a preload from the urging member via the driving force receiving unit. In addition, preferably, the drive device used in a head-up display device includes a frame configured to rotatably support the lead screw on one side of the frame, where the drive unit is fixed on the other side of the frame, and the fixed support unit is on the other side of the movable member. Also, preferably, the mirror holder pivots in a state of always contacting with the fixed support unit. In addition, preferably, a first nut member and a fixed support unit are fixed to the movable member, and the first nut member and the fixed support unit are arranged at substantially the same position in an axis direction of the lead screw. Such an arrangement enables suppression of a rattling of components, which is a problem in the head-up display device, by the drive device.

### Effect of the Invention

In the drive device and the drive device used in a head-up display device according to the present invention, it is possible to suppress a rattling of the movable member in a movement direction.

### BRIEF DESCRIPTION OF THE DRAWINGS

FIG. 1 is a diagram illustrating a schematic configuration of a head-up display device according to an embodiment of the present invention.

FIG. 2 is a schematic cross-sectional view of a display device of the head-up display device illustrated in FIG. 1.

FIG. 3 is a schematic perspective view illustrating a drive device according to the present embodiment.

FIG. 4 is a schematic side view illustrating a drive device according to the present embodiment.

FIG. 5 is an enlarged schematic perspective view illustrating a movable member according to the present embodiment.

FIG. 6 is a schematic perspective view illustrating an elastic member according to the present embodiment.

FIG. 7 is a schematic perspective view illustrating an elastic member fixing unit according to the present embodiment.

FIG. 8 is a schematic perspective view of the elastic member fixing unit illustrated in FIG. 7 when viewed from another direction.

FIG. 9 is a schematic perspective view illustrating a support member according to the present embodiment.

FIG. 10 is a perspective side view of the movable member illustrated in FIG. 5.

FIG. 11 is a perspective top view of the movable member illustrated in FIG. 5.

(a) and (b) of FIG. 12 is a schematic side view of the drive device according to the present embodiment when viewed from a side opposite to FIG. 4.

FIG. 13 is a schematic diagram for explaining an operation of a nut unit according to the present embodiment.

### MODE FOR CARRYING OUT THE INVENTION

Embodiments of the present invention now will be described with reference to the drawings.

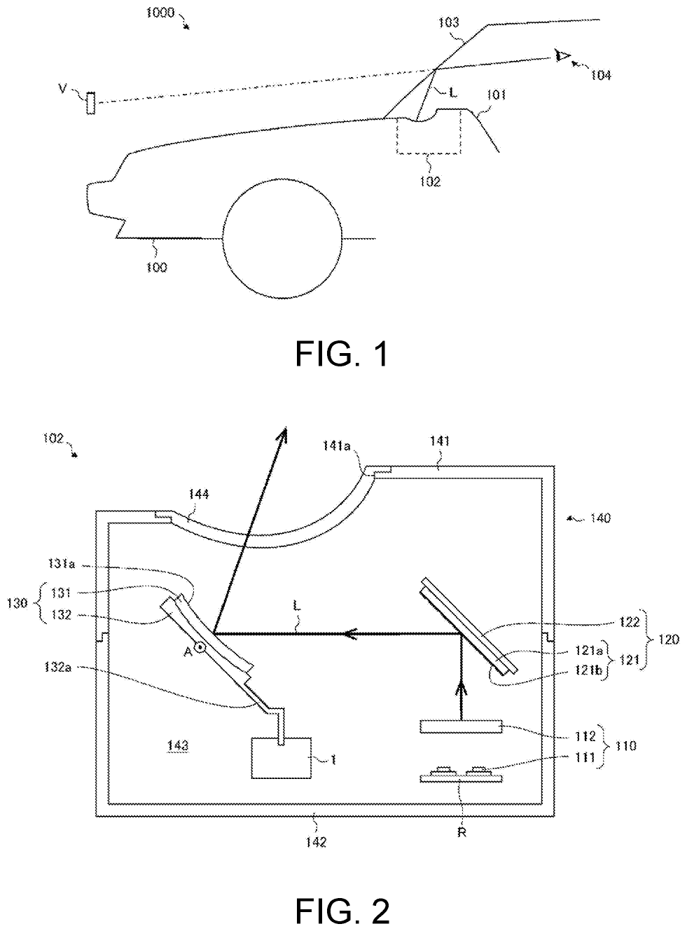

First, a head-up display device for a vehicle to which the present invention is applied will be described with reference to FIG. 1 and FIG. 2. FIG. 1 is a diagram illustrating a schematic configuration of a head-up display device according to an embodiment of the present invention. FIG. 2 is a schematic cross-sectional view of a display device of the head-up display device according to the present embodiment.

As illustrated in FIG. 1, a head-up display device 1000 includes a display device 102 provided inside an instrument panel 101 of a vehicle 100, and reflects, by a windshield 103 being a projection member, display light L projected by the display device 12 in the direction of a driver 104 of the vehicle 100, and displays a virtual image (display image) V. In other words, the head-up display device irradiates (projects) the windshield 103 with the display light L emitted from a liquid crystal display device 110 (described later) of the display device 102, and enables the driver 104 to visually recognize the virtual image V obtained by the irradiation. This allows the driver 104 to observe the virtual image V superimposing on the landscape.

As illustrated in FIG. 2, the display device 102 includes the liquid crystal display device 110, a first reflector 120, a second reflector 130, and a housing 140.

The liquid crystal display device 110 includes a light source 111 and a liquid crystal display element (display element) 112. The light source 111 includes a light emitting diode mounted on a wiring board R. The liquid crystal display element 112 is a thin film transistor (TFT) type liquid crystal display element located in front of (directly above) the light source 111 to transmit illumination light from the light source 111 to form the display light L. The liquid crystal display element 112 emits and displays information to be displayed (for example, a vehicle speed and an engine rpm) in a numerical value or the like according to the light emitted from the light source 111 arranged behind (directly below) based on a drive signal from an element drive circuit (not illustrated). It is noted that the information to be displayed is not limited to a vehicle speed and an engine rpm, and the display form is also not limited to the numerical display, and may be any form. The liquid crystal display device 110 outputs the display light L composed of light in the visible wavelength range, and, for example, may employ a light source 111 that emits red light (mainly in an emission wavelength range of 610 to 640 nm).

Such a liquid crystal display device 110 is provided in the housing 140 such that the surface on the emission side of the display light L faces a cold mirror 121 of the first reflector 120 (described later), and the optical axis of the display light L is fixedly held at a position and an orientation to cross the cold mirror 121.

The first reflector 120 includes the cold mirror 121 and an attachment member 122 for fixing the cold mirror 121 to the housing 140. The cold mirror 121 reflects the display light L emitted from the liquid crystal display device 110 toward the second reflector 130 (the concave mirror 131). The cold mirror 121 includes a substantially rectangular glass substrate 121a, and a first reflective layer 121b formed on one surface of the glass substrate 121a (the surface facing the concave mirror 131 described later of the second reflector 130) by vapor deposition or the like and formed of an interference film having multiple layers of different thickness. The attachment member 122 is formed of, for example, a black synthetic resin material, and is fixed to the housing 140.

The cold mirror 121 reflects light in the visible wavelength range (450 to 750 nm) including the emission wavelength range of the liquid crystal display device 110 with a high reflectance (for example, 80% or more), and light outside the visible wavelength range with a low reflectance. In this case, a cold mirror that reflects light outside the visible wavelength range, particularly, light in the infrared wavelength range (infrared rays or heat rays of sunlight) with a low reflectance (for example, 15% or less) is applied to the cold mirror 121. It is noted that light not reflected by the first reflective layer 121b transmits through the cold mirror 121. In the present embodiment, similarly to the liquid crystal display device 110, the cold mirror 121 is arranged at a position not directly visible from a translucent cover 144 (described later) of the housing 140, and light from outside (external light) such as sunlight does not directly hit the cold mirror 121.

The second reflector 130 includes the concave mirror 131 and a mirror holder 132 holding the concave mirror 131. The concave mirror 131 includes a second reflective layer 131a vapor-deposited on the concave surface of a resin substrate made of polycarbonate, and reflects the display light L from the cold mirror 121 (that is, the liquid crystal display element 112) toward the windshield 103 through the translucent cover 144 of the housing 140 while expanding the display light L. The concave mirror 131 is arranged such that the second reflective layer 131a faces the cold mirror 121 and the translucent cover 144 of the housing 140, and is arranged at a position visible from the translucent cover 144.

The mirror holder 132 is made of a synthetic resin material, and includes a rotational axis A which is orthogonal to the optical axis of the display light L and is pivotally supported by a bearing unit provided in the housing 140. That is, the mirror holder 132 and the concave mirror 131 held by the mirror holder 132 are pivotable about the rotational axis A, and thus, it is possible to adjust an angular position of the mirror holder 132, that is, a projection direction of the display light L. A protruding piece 132a partially protruding radially outward of the rotational axis A is formed in the mirror holder 132. When the protruding piece 132a moves by the driving force from the drive device 1, the mirror holder 132 is pivoted. The drive device 1 will be described in detail below.

The housing 140 is formed of, for example, aluminum die-cast, and includes an upper case body 141 and a lower case body 142 each having a substantially U-shaped cross section. The upper case body 141 and the lower case body 142 form an internal space 143, and the liquid crystal display device 110, the first reflector 120, and the second reflector 130 are housed in the internal space 143.

An opening 141a is formed in the upper case body 141 at a position facing the concave mirror 131, and the translucent cover 144 is arranged to close the opening 141a. The translucent cover 144 is made of a translucent synthetic resin material (for example, acrylic resin), and functions as a light-transmitting member through which the display light L reflected by the concave mirror 131 is transmitted (passed). In other words, the display light L reflected by the concave mirror 131 is projected on the windshield 103 through the translucent cover 144 provided on the housing 140, whereby the virtual image V is displayed.

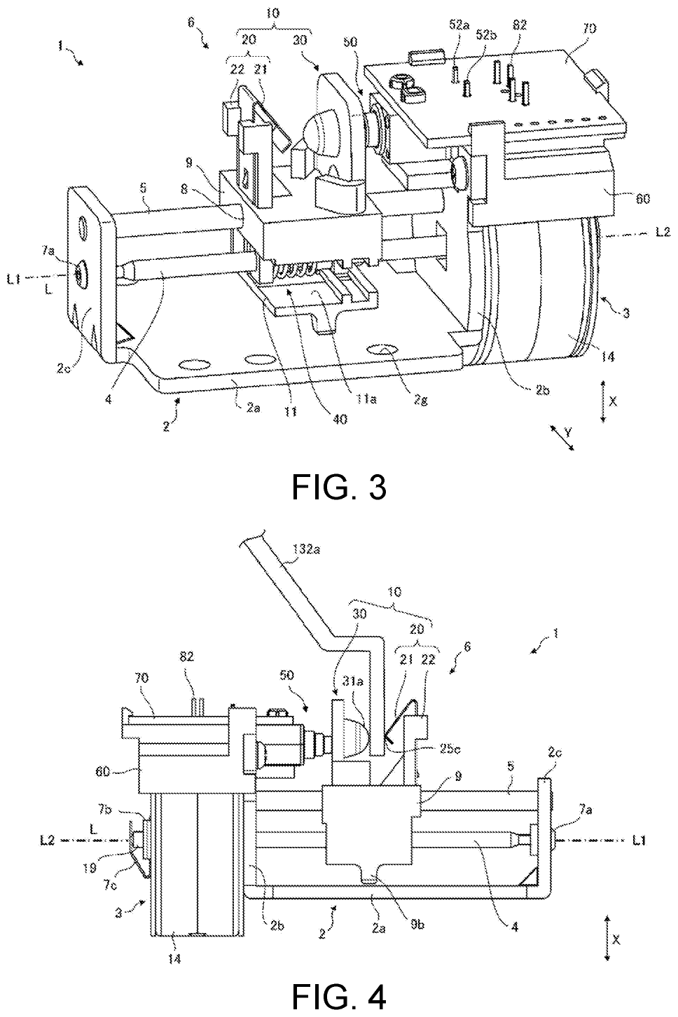

Next, the drive device according to the present embodiment will be described with reference to FIG. 3 and FIG. 4. FIG. 3 is a schematic perspective view illustrating the drive device according to the present embodiment, and FIG. 4 is a schematic side view illustrating the drive device according to the present embodiment, and illustrates a state in which the protruding piece of the mirror holder is supported. In the following description, in a direction in which an axis L of a lead screw 4 (shaft 19) extends, one side toward which the lead screw 4 protrudes is defined as an output side L1, and the opposite side (the other side) to the side toward which the lead screw 4 protrudes is defined as a non-output side L2. In addition, a direction in which support units 2c and 2b of a frame 2 extend, with respect to an axis L direction, is defined as an X direction, and a direction orthogonal to the X direction and the axis L direction is defined as a Y direction.

The drive device 1 includes the lead screw 4 of which an outer peripheral surface has a spiral groove formed therein, a drive unit 3 configured to rotationally drive the lead screw 4 around the axis L, a movable member 6 that engages with the spiral groove and moves in the axis L direction, and the frame 2 configured to support the drive unit 3, etc. A guide shaft 5 arranged in parallel with the lead screw 4 and along the axis L direction is fixed to the frame 2. The drive unit 3 is a motor such as a stepping motor, and generally includes a stator 14 forming the motor case and a rotor (not illustrated) arranged in the stator 14. The rotor includes the shaft 19 and a permanent magnet (not illustrated) fixed to the shaft 19.

The stator 14 is fixed to the support unit 2b of the frame 2 on the non-output side L2 in the axis L direction, by using, for example, welding processing. A substrate holder 60 that holds the power supply substrate 70 is fixed to the support unit 2b by bolts.

A terminal pin 82 serving as a power feeding unit is provided in the side surface of the stator 14 and is electrically connected to the power supply substrate 70. A terminal portion (not illustrated) of the drive coil of the stator 14 is wound around the terminal pin 82. The terminal pin 82 is soldered to the power supply substrate 70 to achieve electrical connection between a power supply substrate 80 and the drive coil.

A switch unit 50 is attached to the power supply substrate 70. The switch unit 50 is a push-type switch for detecting the origin position in the movement direction (the axis L direction) of the movable member 6. The switch unit 50 and the power supply substrate 70 are electrically connected by soldering the terminal pins 52a and 52b of the switch unit 50 and the power supply substrate 70.

The frame 2 includes a plate-shaped frame main body 2a and the pair of support units 2b and 2c which are formed by bending both longitudinal ends of the frame main body 2a. The frame 2 is fixed to the housing 140 by using a hole 2g formed in the frame main body 2a. The drive unit 3 is fixed to the support unit 2b on the non-output side L2 in the axis L direction.

The lead screw 4 is formed integrally with the shaft 19 of the drive unit 3, and formed by a part of the shaft 19 (a portion protruding from the stator 14 toward the output side L1 in the axis L direction) of which the outer peripheral surface has a spiral groove formed therein. Therefore, the lead screw 4 is rotationally driven by the drive unit 3. The lead screw 4 is placed in substantially parallel with the frame main body 2a. The tip of the lead screw 4 on the output side L1 in the axis L direction is rotatably supported by a bearing 7a provided on the support unit 2c of the frame 2 on the output side L1 in the axis L direction. Further, the end of the shaft 19 on the non-output side L2 in the axis L direction is rotatably supported by a bearing 7b attached to the drive unit 3, and an urging member 7c formed of a leaf spring urges the tip of the end toward the output side L1 in the axis L direction. The guide shaft 5 is arranged in parallel with the lead screw 4, and both ends of the guide shaft 5 are fixed to the support units 2b and 2c of the frame 2, respectively. In the present embodiment, the guide shaft 5 is placed to overlap the lead screw 4 in the X direction.

The movable member 6 includes a nut unit 40 that meshes with the lead screw 4 and moves in the axis L direction, a main body unit 9 moving together with the nut unit 40 in the axis L direction, and a support unit 10 that is provided above the main body unit 9 and supports the protruding piece 132a of the mirror holder 132 being the member to be supported. The main body unit 9 includes a guide hole 8 through which the guide shaft 5 extends and a nut arrangement unit 11 in which the nut unit 40 is placed. As the drive unit 3 rotates the lead screw 4, the nut unit 40 correspondingly reciprocates in the axis L direction, and thus, the movable member 6 reciprocates in the axis L direction while being guided by the guide shaft 5. As a result, the protruding piece 132a reciprocates in the axis L direction, whereby it is possible to pivot the mirror holder 132 at a predetermined angle about the rotational axis A (see FIG. 2).

(Support Unit)

The support unit 10 includes an elastic support unit 20, and a fixed support unit 30 on the non-output side L2 in the axis L direction to face the elastic support unit 20. The elastic support unit 20 urges the protruding piece 132a of the mirror holder 132 toward the non-output side L2 in the axis L direction. The fixed support unit 30 supports the protruding piece 132a urged by the elastic support unit 20. According to such a configuration, the protruding piece 132a is always supported by the elastic support unit 20 while being pressed against the fixed support unit 30. Therefore, it is possible to always position the protruding piece 132a with reference to the fixed support unit 30, and, for example, even if there is a movement or vibration, the position of the protruding piece 132a can be hardly shifted. At the same time, even if the vehicle vibrates as a result of the urging force of the elastic support unit 20, it is possible to prevent the protruding piece 132a from rattling, and also suppress the occurrence of blurring in the display image. As a result, the support unit 10 of the present embodiment improves the positioning accuracy of the protruding piece 132a of the mirror holder 132.

The elastic support unit 20 includes an elastic member 21 that abuts against the protruding piece 132a of the mirror holder 132 to urge the protruding piece 132a toward the fixed support unit 30, and an elastic member fixing unit 22 that fixes the elastic member 21. The elastic member fixing unit 22 is made of a synthetic resin material such as polyacetal, and is formed integrally with the main body unit 9. The elastic member fixing unit 22 may be formed separately from the main body unit 9, and then fixed to the main body unit 9 by a method such as bonding.

The fixed support unit 30 is made of a metal such as stainless steel. The fixed support unit 30 is formed of a material having higher rigidity than the main body unit 9 made of resin. The fixed support unit 30 is formed integrally with the main body unit 9 by using insert molding processing. Therefore, the fixed support unit 30 is partially embedded in and fixed to the main body unit 9. With such a configuration, it is possible to improve the strength of the fixed support unit 30 as compared with a case where the fixed support unit 30 is formed integrally with the main body unit 9 by using resin. As a result, it is possible to increase the resonance frequency of the entire head-up display device 1000, suppress the occurrence of resonance due to the vibration of the vehicle, and thus, it is possible to suppress occurrence of blurring in a display image.

(Elastic Support Unit)

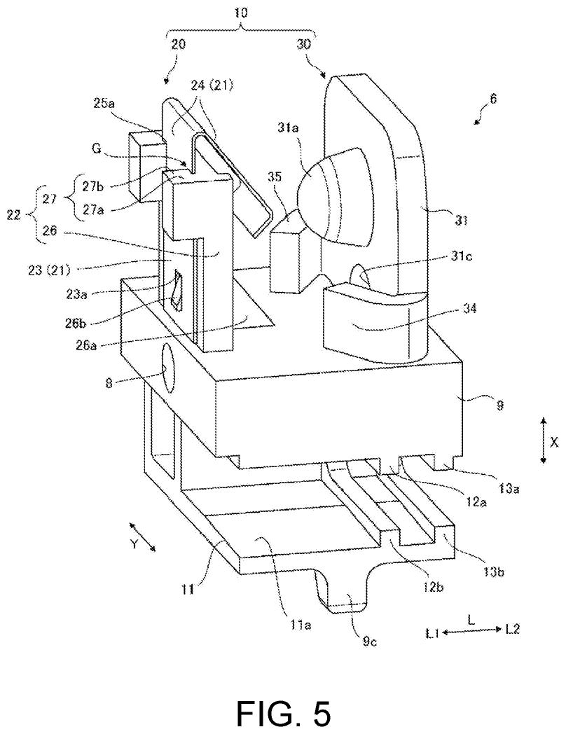

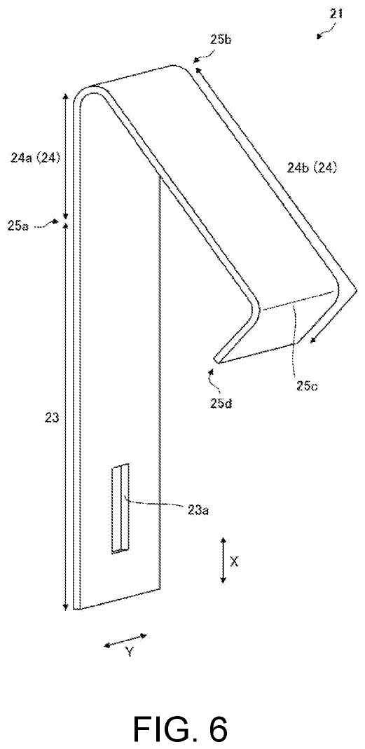

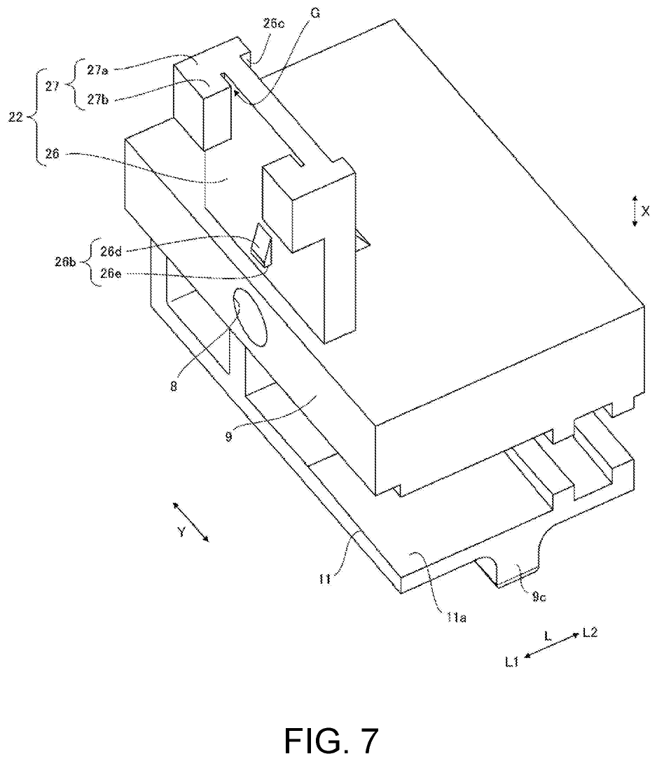

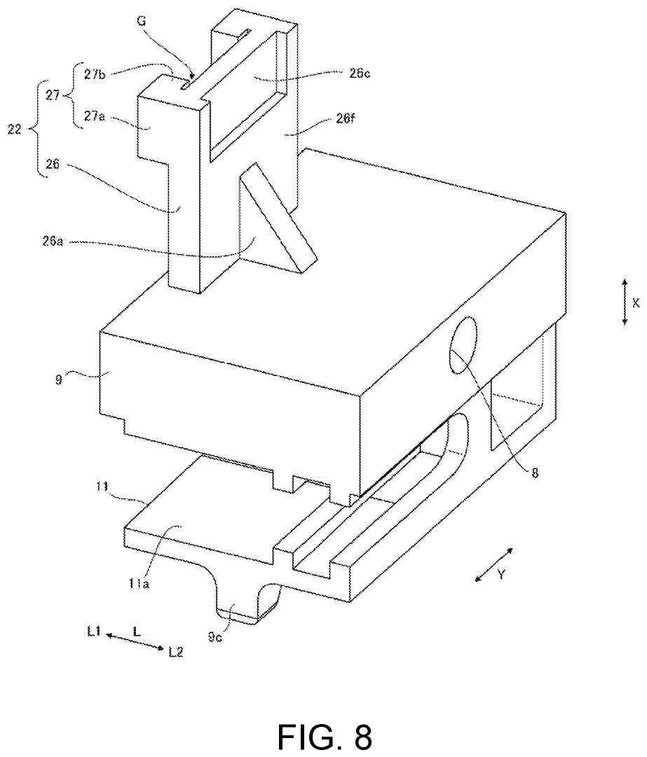

With reference to FIG. 5 to FIG. 8, a detailed configuration of the elastic support unit of the present embodiment will be described. FIG. 5 is an enlarged schematic perspective view illustrating a movable member according to the present embodiment. It is noted that for simplicity, the illustration of the nut unit is omitted in FIG. 5. FIG. 6 is a schematic perspective view illustrating an elastic member according to the present embodiment. FIG. 7 is a schematic perspective view illustrating an elastic member fixing unit according to the present embodiment, and FIG. 8 is a schematic perspective view of the elastic member fixing unit illustrated in FIG. 7 when viewed from another direction. It is noted that for simplicity, the illustration of the fixed support unit is omitted in FIG. 7 and FIG. 8.

As illustrated in FIG. 6, the elastic member 21 includes a fixed plate unit 23 attached and fixed onto the elastic member fixing unit 22, and an elastically deformable plate unit 24 extending from an end of the fixed plate unit 23 and being elastically deformable. The elastic member 21 in the present embodiment is a leaf spring having a relatively wide width (length in the Y direction). A first locking unit 23a to be locked with a second locking unit 26b of the elastic member fixing unit 22 is formed on the fixed plate unit 23, and the first locking unit 23a in the present embodiment is a long opening in the X direction. The elastically deformable plate unit 24 includes a first elastic unit 24a extending from an end of the fixed plate unit 23, and a second elastic unit 24b obliquely extending from an end of the first elastic unit 24a toward the non-output side L2 in the axis L direction. The first elastic unit 24a extends on an extended line of the fixed plate unit 23 (in the X direction in which the fixed plate unit 23 extends), and the second elastic unit 24b extends at an acute angle with respect to the first elastic unit 24a. A first fulcrum unit 25a is formed between the fixed plate unit 23 and the first elastic unit 24a. As illustrated in FIG. 5, the first fulcrum unit 25a is defined as a contact unit between the elastic member 21 and an upper end of the elastic member fixing unit 22. In other words, the first fulcrum unit 25a is defined as a boundary between a region held by the elastic member fixing unit 22 of the elastic member 21 and a region not held by the elastic member fixing unit 22. The first elastic unit 24a is elastically deformable with respect to the fixed plate unit 23 using the first fulcrum unit 25a as a fulcrum. Moreover, a second fulcrum unit 25b being a bent unit of the elastically deformable plate unit 24 is formed between the first elastic unit 24a and the second elastic unit 24b, and by using the second fulcrum unit 25b as a fulcrum, the second elastic unit 24b is elastically deformable with respect to the first elastic unit 24a.

Further, the second elastic unit 24b of the elastically deformable plate unit 24 is bent such that the distal end side of the second elastic unit 24b faces the fixed plate unit 23. The bent unit functions as a protruding piece abutment unit 25c abutting against the protruding piece 132a of the mirror holder 132. In addition, since the protruding piece abutment unit 25c is bent to form a curved surface, it is possible to prevent the protruding piece abutment unit 25c from getting caught when the protruding piece 132a is supported. The protruding piece abutment unit 25c may have any shape that does not get caught in the protruding piece 132a and that enables the protruding piece 132a to move smoothly, and may have a chamfered shape instead of a curved surface. Further, when the elastically deformable plate unit 24 undergoes a large elastic deformation, the bent distal end functions as a fixed unit abutment unit 25d abutting against the elastic member fixing unit 22. For example, even if a large impact acts on the elastically deformable plate unit 24 due to a collision of a vehicle, or the like, the fixed unit abutment unit 25d abuts against the elastic member fixing unit 22 so that it is possible to prevent excessive deformation, that is, plastic deformation of the elastically deformable plate unit 24. It is noted that the shape of the second elastic unit 24b is not limited to the illustrated example, and may be, for example, an arc shape or an S-shape.

As illustrated in FIG. 7 and FIG. 8, the elastic member fixing unit 22 includes a protruding unit 26 protruding from the main body unit 9 in the X direction, and a pair of restricting units 27 provided at the distal end in the protruding direction (X direction) and both ends in the width direction (Y direction) of the protruding unit 26. A reinforcing rib 26a is provided between the protruding unit 26 and the main body unit 9 to connect the protruding unit 26 and the main body unit 9 to each other. The reinforcing rib 26a is provided to reinforce the weakest portion in terms of strength when a load is applied to the elastic member fixing unit 22. That is, a load is applied to the elastic member fixing unit 22 in the axis L direction from the non-output side L2 to the output side L1, and in such a case, a portion that is weakest in terms of strength and tends to be easily broken is the base of the protruding unit 26 on the non-output side L2. The reinforcing rib 26a is provided in this portion, and is formed in a plate shape extending in a direction in which a load is applied (the axis L direction). The pair of restricting units 27 are formed on the surface of the protruding unit 26 on the output side L1 in the axis L direction. A gap G having an interval substantially equal to the thickness of the elastic member 21 is formed between the restricting units 27 and the surface of the protruding unit 26, and the elastic member 21 is inserted into the gap G. Each of the restricting units 27 includes a lateral restricting unit 27a protruding in the axis L direction from the surface of the protruding unit 26 on the output side L1, and a rear restricting unit 27b extending inward from the lateral restricting unit 27a along the Y direction. The lateral restricting unit 27a restricts a movement in the Y direction of the fixed plate unit 23 of the elastic member 21 inserted into the gap G, and the rear restricting unit 27b restricts a movement in the axis L direction of the fixed plate unit 23. Thus, the elastic member 21 is attached to the elastic member fixing unit 22 such that a movement of the elastic member 21 in a direction (the Y direction and the axis L direction) intersecting with the insertion direction of the fixed plate unit 23 inserted into the gap G is restricted.

Further, a second locking unit 26b to lock with the first locking unit 23a formed on the fixed plate unit 23 is formed on the surface on the output side L1 in the axis L direction of the protruding unit 26. The second locking unit 26b has a so-called snap-fit shape, and includes a guide surface 26d inclined with respect to the surface on the output side L1 in the axis L direction of the protruding unit 26, on the upper side in the X direction, and a locking surface 26e substantially perpendicular to the surface on the output side L1 in the axis L direction of the protruding unit 26, on the lower side in the X direction. When the fixed plate unit 23 is inserted into the gap G and the first locking unit (opening) 23a is locked to the locking surface 26e, it is possible to restrict a movement of the fixed plate unit 23 in the X direction, and also prevent the fixed plate unit 23 from coming off. It is noted that when the fixed plate unit 23 is inserted into the gap G and fixed, the boundary between the region held by the elastic member fixing unit 22 of the elastic member 21 and the region not held by the elastic member fixing unit 22 is the first fulcrum unit 25a described above.

A step unit 26c is formed at the distal end in the X direction on the surface of the protruding unit 26 on the non-output side L2 in the axis L direction. The step unit 26c includes a width (length in the Y direction) wider than the width of the second elastic unit 24b of the elastically deformable plate unit 24. As a result, the step unit 26c functions as a relief unit configured to avoid interference with the second elastic unit 24b of the elastically deformable plate unit 24, and also expands the movable range of the elastically deformable plate unit 24. In other words, the step unit 26c is located at a corner of the protruding unit 26 facing the second elastic unit 24b, and when the elastically deformable plate unit 24 is bent, the second elastic unit 24b does not to come in contact with the corner. A receiving surface 26f against which the fixed unit abutment unit 25d of the elastically deformable plate unit 24 abuts is formed on the lower side of the step unit 26c in the X direction, that is, the fixed unit abutment unit 25d does not come in contact with the step unit 26c. As a result, it is possible to increase the pivoting range of the elastically deformable plate unit 24.

In the illustrated example, the elastic member 21 is attached to the surface of the elastic member fixing unit 22 on the output side L1 in the axis L direction, but may be attached to the surface on the non-output side L2 in the axis L direction, and the attaching method is also not limited to the snap-fit method as illustrated, and for example, a screw, an adhesive, or the like may be used. Further, the elastic member 21 is not limited to a leaf spring as long as the elastic member 21 urges the protruding piece 132a of the mirror holder 132 toward the fixed support unit 30. For example, the elastic member 21 may be another spring member such as a coil spring, or a member made of an elastic material such as rubber.

(Fixed Support Unit)

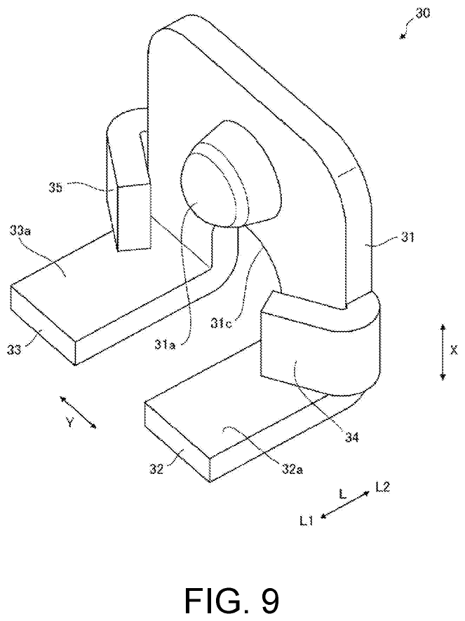

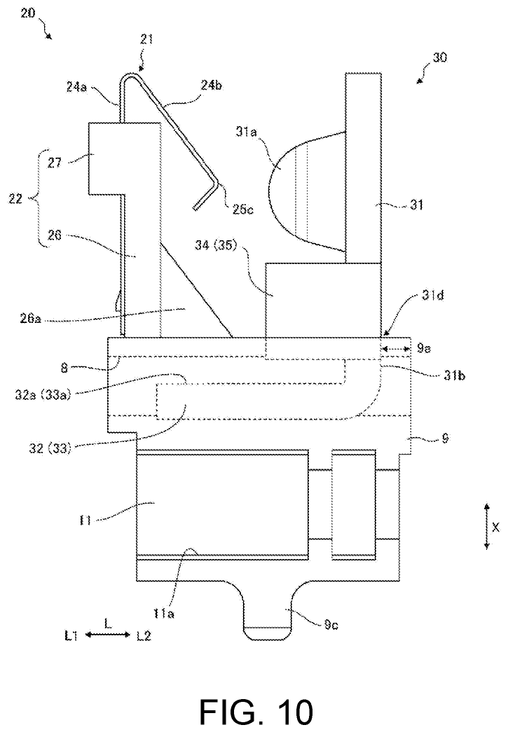

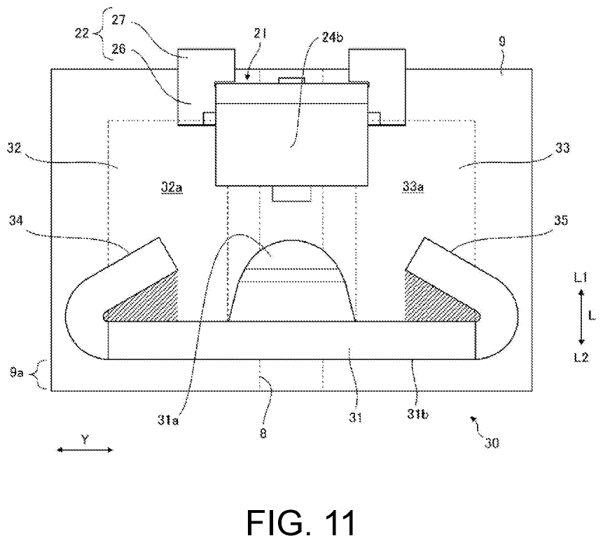

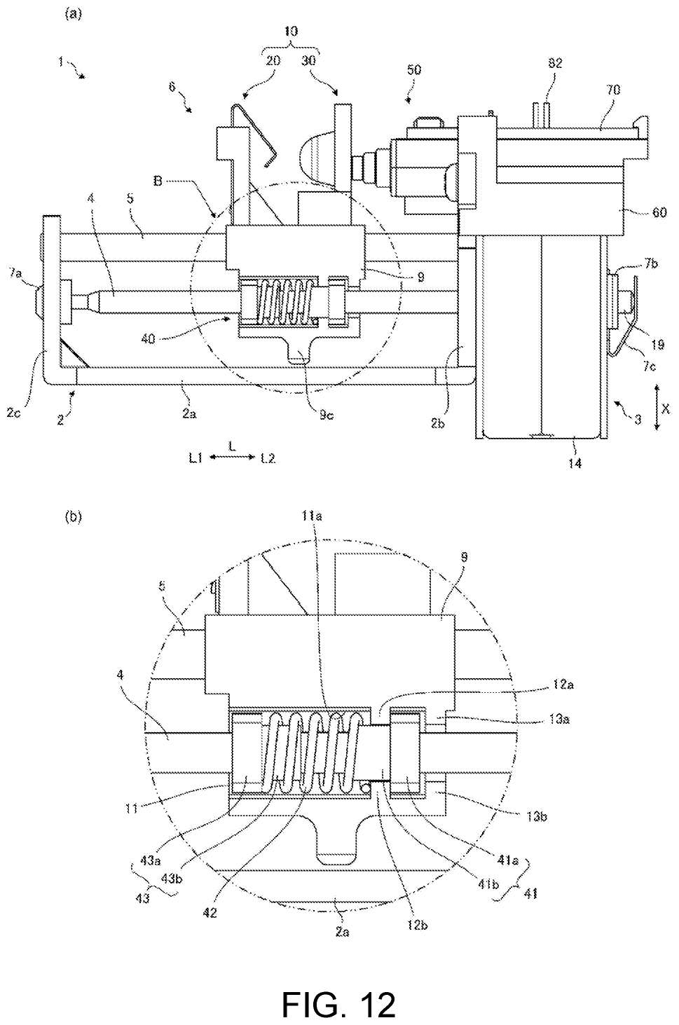

Next, a detailed configuration of the fixed support unit according to the present embodiment will be described with reference to FIG. 9 to FIG. 11 in addition to FIG. 5. FIG. 9 is a schematic perspective view illustrating a fixed support unit according to the present embodiment. FIG. 10 and FIG. 11 are a perspective side view and a perspective top view, respectively, of the movable member illustrated in FIG. 5.

As illustrated in FIG. 9, the fixed support unit 30 includes a support main body unit 31, a pair of extending units 32 and 33, and a pair of arm units 34 and 35. The support main body unit 31 extends in the X direction, the pair of extending units 32 and 33 extend from an end of the support main body unit 31 in the axis L direction (the movement direction of the movable member 6), and the pair of arm units 34 and 35 extend substantially in the axis L direction from both ends of the support main body unit 31 in the Y direction.

The support protrusion 31a protruding toward the elastic support unit 20 which faces the support main body unit 31 at the output side L1 in the axis L direction is formed in the support main body unit 31. The support protrusion 31a can support the protruding piece 132a of the mirror holder 132 urged by the elastic support unit 20. Further, the support protrusion 31a is formed in a hemispherical shape. As a result, even if the inclination of the protruding piece 132a of the mirror holder 132 changes significantly due to the movement of the movable member 6, the protruding piece 132a are supported in the same manner. However, the support protrusion 31a is not limited to the illustrated shape as long as the distal end of the support protrusion 31a is curved.

In the support main body unit 31, at least upper surfaces 32a and 33a of the extending units 32 and 33 are covered and held by the main body unit 9. As a result, it is possible to reliably prevent the fixed support unit 30 from coming off in the X direction with respect to the main body unit 9.

Further, in the support main body unit 31, the lower end (the portion opposite to the extending units 32 and 33 in the axis L direction) 31b on the non-output side L2 in the axis L direction is covered and held by a holding and fixing unit 9a of the main body unit 9. Accordingly, it is possible to not only prevent the fixed support unit 30 from coming off in the X direction, but also reliably prevent the fixed support unit 30 from coming off in the axis L direction.

It is noted that a guide hole 8 into which the guide shaft 5 configured to guide a movement of the movable member 6 is fitted is formed in the main body unit 9. The pair of extending units 32 and 33 are arranged in the main body unit 9 not to overlap the guide hole 8. A cutout unit 31c is formed in the support main body unit 31, the cutout unit 31c and the guide hole 8 are arranged to overlap in the axis L direction, and the pair of extending units 32 and 33 each extend in the axis L direction from the lower end of the support main body unit 31 divided into two parts in the Y direction by the cutout unit 31c. Further, the pair of extending units 32 and 33 are arranged parallel with the guide hole 8 on both sides of the guide hole 8 in the main body unit 9 in the Y direction while partially overlapping the guide hole 8 in the X direction. Thus, even in a limited space, the extending units 32 and 33 are effectively arranged to effectively exhibit the effect of preventing the fixed support unit 30 from coming off. It is noted that the number of the extending units may be one.

In the present embodiment, the distal end of the extending units 32 and 33 reaches the surface of the protruding unit 26 of the elastic support unit 20 on the non-output side L2 in the axis L direction, and the width of the extending units 32 and 33 in the Y direction (the length from one end to the other end in the Y direction) is the same as that of the support main body unit 31. Further, the lower surface of the extending units 32 and 33 reaches the lower end of the guide hole 8 in the X direction. With such an arrangement of the extending units 32 and 33, it is possible to increase the contact area with the main body unit 9, and to hold the fixed support unit 30 more firmly. As a result, it is possible to more reliably prevent the fixed support unit 30 from coming off.

The pair of arm units 34 and 35 are partially embedded in the main body unit 9. As a result, it is possible to further increase the contact area of the fixed support unit 30 with the main body unit 9, and to hold the fixed support unit 30 more firmly. Further, for example, if the pair of arm units 34 and 35 are not provided, when the stress in the axis L direction is excessively applied to the support main body unit 31, the stress may be concentrated in the base end 31d of the support main body unit 31 (the base portion exposed from the main body unit 9), and the base end 31d may break. In contrast, in the present embodiment, since the pair of arm units 34 and 35 are partially embedded in the main body unit 9, it is possible to increase the cross-sectional area of the fixed support unit 30 along the upper surface of the main body unit 9. As a result, it is possible to disperse the stress acting on the support main body unit 31, and thus, it is possible to improve the durability against the above-mentioned stress.

It is noted that the pair of arm units 34 and 35 extend obliquely with respect to the axis L direction so that the interval between the arm units 34 and 35 decreases as the distance from the support main body unit 31 increases. As a result, even if the size of the main body unit 9 is limited, it is possible to suppress the formation of a portion where the resin is thinner outside the pair of arm units 34 and 35. Further, since the pair of arm units 34 and 35 extend obliquely, a portion (portion indicated by slant lines in FIG. 11) is formed between the pair of arm units 34 and 35 and the support main body unit 31 to hold the resin, and therefore, it is possible to further strengthen the integration between the fixed support unit 30 and the main body unit 9. However, the shape of the pair of arm units 34 and 35 is not limited to the illustrated shape, for example, if there is a margin in the size of the main body unit 9 in the Y direction, and a resin having sufficient thickness is secured outside the pair of arm units 34 and 35, the pair of arm units 34 and 35 may extend in parallel with the axis L direction.

In the present embodiment, the fixed support unit 30 is made of metal and is fixed to the main body unit 9 made of resin by insert molding, but the material and the fixing method of the fixed support unit 30 are not limited to these. The material of the fixed support unit 30 may be resin as long as the rigidity is higher than that of the main body unit 9, and the fixing method may be, for example, a press-fitting method.

(Nut Unit)

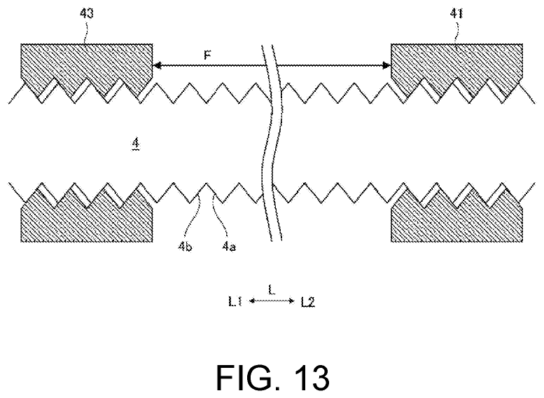

Next, a detailed configuration of the nut unit 40 used in the drive device 1 according to the present embodiment will be described with reference to (a) and (b) of FIG. 12. (a) of FIG. 12 is a schematic side view of the drive device according to the present embodiment when viewed from a side opposite to FIG. 4, and (b) of FIG. 12 is an enlarged side view of a region surrounded by a circle B in (a) of FIG. 12. FIG. 13 is a schematic diagram for explaining an operation of the nut unit according to the present embodiment.

The nut unit 40 includes a first nut member 41, a coil spring 42, and a second nut member 43, and is arranged in a groove-shaped nut arrangement unit 11 formed in the main body unit 9. The first nut member 41 and the second nut member 43 are screwed together with the lead screw 4, and the lead screw 4 passes through the inside of the coil spring 42.

The first nut member 41 includes a flange unit 41a having a rectangular outer shape, and a tubular unit 41b extending from the flange unit 41a in the axis L direction, and a thread unit to be screwed together with the lead screw 4 is formed inside the flange unit 41a and the tubular unit 41b. The second nut member 43 also includes a flange unit 43a having a rectangular outer shape, and a tubular unit 43b extending from the flange unit 43a in the axis L direction, and a thread unit to be screwed together with the lead screw 4 is formed inside the flange unit 43a and the tubular unit 43b. The first nut member 41 and the second nut member 43 are arranged in the nut arrangement unit 11 such that the tubular units 41a and 43a face each other. The flange unit 41a of the first nut member 41 abuts against a pair of opposing ribs 12a and 12b protruding from the inner surface 11a of the nut arrangement unit 11. It is noted that another pair of opposing ribs 13a and 13b are formed on the inner surface 11a of the nut arrangement unit 11 on the non-output side L2 in the axis L direction of the first nut member 41, but this pair are provided to facilitate the positioning between the nut unit 40 (the first nut member 41) and the movable member 6.

The coil spring 42 is arranged between the pair of opposing ribs 12a and 12b and the second nut member 43 in a compressed state. Therefore, the coil spring 42 abuts against the pair of opposing ribs 12a and 12b at one end of the coil spring 42, and urges the pair of opposing ribs 12a and 12b toward the non-output side L2 in the axis L direction to abut against the flange unit 41a of the first nut member 41. Further, the coil spring 42 abuts against the flange unit 43a of the second nut member 43 at the other end of the coil spring 42, and urges the flange unit 43a of the second nut member 43 toward the output side L1 in the axis L direction. It is noted that in the present embodiment, since the other pair of opposing ribs 13a and 13 b are provided, it is possible to prevent the distance between the pair of opposing ribs 12a and 12b and the second nut member 43 from being too short when the nut unit 40 is arranged in the nut arrangement unit 11. Therefore, it is possible to prevent the coil spring 42 from being excessively compressed and the coil spring 42 from coming off the tubular unit 41b of the first nut member 41.

The flange unit 41a abuts against the inner surface 11a of the nut arrangement unit 11, and thus, the rotation of the first nut member 41 with respect to the main body unit 9 is restricted. In other words, the inner surface 11a of the nut arrangement unit 11 abuts against the flange unit 41a of the first nut member 41 to function as a restricting unit configured to restrict the rotation of the first nut member 41. Further, as described above, the first nut member 41 is applied with an urging force (preload) from the coil spring 42 toward the non-output side L2 in the axis L direction via the pair of opposing ribs 12a and 12b, and the flange unit 41a always abuts against the pair of opposing ribs 12a and 12b. For this reason, the first nut member 41 functions as a driving force transmitting unit configured to transmit a driving force of the drive unit 3 to the main body unit 3, and the pair of opposing ribs 12a and 12b function as a driving force receiving unit configured to receive a driving force of the drive unit 3 from the first nut member 41. As a result, it is possible to cause the main body unit 9 to reciprocate in the axis L direction with a rotation of the lead screw 4.

The flange unit 43a abuts against the inner surface 11a of the nut arrangement unit 11, and thus, the rotation of the second nut member 43 with respect to the main body unit 9 is restricted. In other words, the inner surface 11a of the nut arrangement unit 11 abuts against the flange unit 43a of the second nut member 43 to function as a restricting unit configured to restrict the rotation of the second nut member 43. On the other hand, the second nut member 43 is not supported by the main body unit 9 in the axis L direction, and, as described above, is applied with an urging force (preload) from the coil spring 42 toward the output side L1 in the axis L direction. As a result, the second nut member 43 functions as a preload applying unit together with the coil spring 42, and applies a preload F in a direction away from each other, between the thread unit of the first nut member 41 and the thread unit of the second nut member 43 as illustrated in FIG. 13.

With such preload F, when the movable member 3 is moved by the first nut member 41, the thread unit of the first nut member 41 can be caused to abut against a flank surface 4a on the non-output side of the lead screw 4. Further, the thread unit of the second nut member 43 is abutted against a flank surface 4b on the output side of the lead screw 4. As a result, it is possible to absorb a clearance (backlash) between the lead screw 4 and each of the nut members (thread units), and thus it is possible to suppress a rattling of the movable member 6 in a movement direction (the axis L direction).

It is noted that as described above, the coil spring 42 abuts against the movable member 6 (the pair of opposing ribs 12a and 12b) at one end of the coil spring 42, and abuts against the second nut member 43 at the other end of the coil spring 42, and the movable member 6 abuts against the flange unit 41a of the first nut member 41. Therefore, if the movable member 6 moves to the output side L1 in the axis L direction, the thrust of the first nut member 41 is transmitted to the movable member 6 as a driving force via the flange unit 41a, and if the movable member 6 moves to the non-output side L2 in the axis L direction, the driving force is transmitted to the movable member 6 through the first nut member 41 by the urging force of the coil spring 42. As a result, the movable member 6 is movable to both the output side L1 and the non-output side L2 in the axis L direction, and even in this case, as described above, it is possible to suppress a rattling of the movable member 6 by the single coil spring 42.

In the present embodiment, the nut arrangement unit 11 configured to accommodate the nut unit 40 does not open in a direction (X direction) in which the main body unit 9 and the frame main body 2a face each other, but opens in a direction (Y direction) crossing the direction in which the main body unit 9 and the frame main body 2a face each other. This is particularly preferable in that it is possible to improve the workability when the nut unit 40 is placed in the nut arrangement unit 11. That is, if the nut arrangement unit 11 opens in the direction facing the frame main body 2a, it is not possible to visually check inside the nut arrangement unit 11 due to the frame main body 2a, thus making it difficult to accommodate the nut unit 40 in the nut arrangement unit 11 in an appropriate arrangement. On the other hand, in the present embodiment, since the frame main body 2a is not an obstacle when the nut unit 40 is accommodated in the nut arrangement unit 11, it is possible to arrange the nut unit 40 at an appropriate position while visually checking the nut unit 40, and thus it is possible to suppress a drop in yield during assembly.

In the present embodiment, as described above, the guide shaft 5 is placed to overlap the lead screw 4 in the X direction. The support unit 10 is provided to overlap the guide shaft 5 and the lead screw 4 in the X direction. Therefore, it is possible to stabilize the movement of the movable member 6. Further, in the present embodiment, a pair of stoppers 9b and 9c (see FIG. 4 and FIG. 8) for restricting the rotation of the main body unit 9 are provided below the main body unit 9, and the distance from the guide shaft 5 to each of the stoppers 9b and 9c may be substantially equal. Therefore, it is possible to suppress a rattling of the movable member 6 in the rotation direction as much as possible, and thus, it is possible to stabilize a movement of the movable member 6.

In the present embodiment, both the first nut member 41 and the second nut member 43 are provided separately from the main body unit 9, but the first nut member 41 may not necessarily be separate from the main body unit 9 as long as the first nut member 41 moves integrally with the main body unit 9. That is, the first nut member 41 may be physically fixed to the main body unit 9 by a fixing means such as an adhesive, or the first nut member 41 and the main body unit 9 may be integrally formed, and the main body unit 9 itself may include a female thread unit to be screwed together with the lead screw 4.

It is possible to use the drive device described in the present embodiment in a head-up display device for a vehicle.

In the present embodiment, there is provided a frame configured to rotatably support the lead screw on one side of the frame, and to which the drive unit is fixed on the other side of the frame and the fixed support unit may be on the other side of the movable member. Therefore, the mirror holder can pivot in a state of always contacting with the fixed support unit. Further, optimally, the first nut member and the fixed support unit are fixed to the movable member, and the first nut member and the fixed support unit are placed at substantially the same position in the axis direction of the lead screw. In the drive device used in a head-up display device, if such an arrangement is employed, it is possible to absorb or suppress a rattling in components that are important in the head-up display device by the drive device, which makes it unnecessary to provide a separate member for suppressing a rattling in the head-up display device, as a result, enabling simplification of the entire device.

### DESCRIPTION OF REFERENCE NUMERALS

1 . . . Drive device, 2 . . . Frame, 2a . . . Frame main body, 2b, 2c . . . Support unit, 3 . . . Drive unit, 4 . . . Lead screw, 5 . . . Guide shaft, 6 . . . Movable member, 8 . . . Guide hole, 9 . . . Main body unit, 10 . . . Support unit, 11 . . . Nut arrangement unit, 11a . . . Inner surface, 12a, 12b . . . Opposing rib, 20 . . . Elastic support unit, 21 . . . Elastic member, 22 . . . Elastic member fixing unit, 23 . . . Fixed plate unit, 24 . . . Elastically deformable plate unit, 24a . . . First elastic unit, 24b . . . Second elastic unit, 25a . . . First fulcrum unit, 25c . . . Protruding piece abutment unit, 26 . . . Protruding unit, 26a . . . Reinforcing rib, 26b . . . Second locking unit, 26c . . . Step unit, 27 . . . Restricting unit, 30 . . . Fixed support unit, 31 . . . Support main body unit, 31c . . . Cutout unit, 32, 33 . . . Extending unit, 32a, 33a . . . Upper surface (of the extending unit), 34, 35 . . . Arm unit, 40 . . . Nut unit, 41 . . . First nut member, 41a . . . Flange unit, 42b . . . Tubular unit, 42 . . . Coil spring, 43 . . . Second nut member, 43a . . . Flange unit, 43b . . . Tubular unit, 132a . . . Protruding piece (of the mirror holder), G . . . Gap

1. A drive device, comprising:
a drive unit;
a lead screw rotationally driven by the drive unit; and
a movable member being moved by a driving force of the drive unit, wherein
the movable member includes a main body unit, a driving force transmitting unit configured to transmit a driving force of the drive unit to the main body unit, and a preload applying unit provided separately from the main body unit,
the driving force transmitting unit includes a first thread unit to be screwed together with the lead screw and moves the main body unit in an axis direction of the lead screw with a rotation of the lead screw, and
the preload applying unit includes a second thread unit to be screwed together with the lead screw and applies a preload between the first thread unit and the second thread unit.

2. The drive device according to claim 1, wherein
the driving force transmitting unit includes the first thread unit, and includes a first nut member provided separately from the main body unit,
the preload applying unit includes a second nut member including the second thread unit, and an urging member provided between the first nut member and the second nut member,
a nut arrangement unit in which the first nut member and the second nut member are arranged is formed in the main body unit, and
the first nut member and the second nut member are arranged in the nut arrangement unit in a state in which rotation with respect to the main body unit is restricted.

3. The drive device according to claim 2, wherein
a driving force receiving unit configured to receive a driving force of the drive unit from the first nut member is formed in the nut arrangement unit, and
the first nut member is applied with a preload from the urging member via the driving force receiving unit.

4. The drive device according to claim 3, wherein
the urging member includes a coil spring,
the lead screw penetrates an inside of the coil spring, and
the urging member is arranged between the driving force receiving unit and the second nut member.

5. The drive device according to claim 4, wherein
the first nut member includes a tubular unit on which the first thread unit is formed, and a flange unit,
the flange unit abuts against the driving force receiving unit, and
a restricting unit configured to restrict a rotation of the first nut member by abutting against the flange unit is provided in the nut arrangement unit.

6. The drive device according to claim 5, wherein
the second nut member includes a tubular unit on which the second thread unit is formed, and a flange unit, and
a restricting unit configured to restrict a rotation of the second nut member by abutting against the flange unit is provided in the nut arrangement unit.

7. The drive device according to claim 2, comprising a frame configured to rotatably support the lead screw, wherein
the frame includes a plate-shaped frame main body facing the main body unit, and
the nut arrangement unit opens in a direction crossing a direction in which the main body unit and the frame main body face each other.

8. The drive device according to claim 7, wherein
a guide shaft configured to guide a movement of the movable member is attached to the frame,
the guide shaft is arranged in parallel with the lead screw,
the movable member includes a support unit configured to support a supported member, and
the support unit is provided on the opposite side of the lead screw across the guide shaft.

9. The drive device according to claim 1, wherein
the movable member includes a support unit configured to support a supported member, and
the support unit includes an elastic support unit configured to urge the supported member, and a fixed support unit provided to face the elastic support unit in a movement direction of the movable member and configured to support the supported member urged by the elastic support unit.

10. The drive device according to claim 9, wherein
the elastic support unit includes an elastic member configured to abut against the supported member to urge the supported member toward the fixed support unit, and an elastic member fixing unit configured to hold the elastic member, and
the elastic member fixing unit is provided in the main body unit.

11. The drive device according to claim 10, wherein the elastic member includes a leaf spring.

12. The drive device according to claim 11, wherein
the elastic member includes a fixed plate unit attached to the elastic member fixing unit, and an elastically deformable plate unit extending from an end of the fixed plate unit and being elastically deformable,
the elastically deformable plate unit includes a first elastic unit extending from an end of the fixed plate unit, and a second elastic unit extending from an end of the first elastic unit, and
an abutment unit configured to abut against the supported member is formed in the second elastic unit.

13. The drive device according to claim 9, wherein the fixed support unit is formed of a material having higher rigidity than the main body unit, and is partially embedded in and fixed to the main body unit.

14. The drive device according to claim 13, wherein the fixed support unit supports the supported member at a position facing the supported member in a movement direction of the movable member.

15. The drive device according to claim 14, wherein
the fixed support unit includes a support main body unit extending in a direction crossing a movement direction of the movable member, and an extending unit extending from an end of the support main body unit in a movement direction of the movable member, and
at least a part of an upper surface of the extending unit is covered with the main body unit.

16. A drive device used in a head-up display device, comprising:
a drive unit;
a lead screw rotationally driven by the drive unit; and
a movable member being moved by a driving force of the drive unit, wherein
the movable member includes a main body unit, a driving force transmitting unit configured to transmit a driving force of the drive unit to the main body unit, a preload applying unit provided separately from the main body unit, and a support unit configured to pivotably support a mirror holder supporting a concave mirror,
the driving force transmitting unit includes a first thread unit to be screwed together with the lead screw and moves the main body unit in an axis direction of the lead screw with a rotation of the lead screw, and
the preload applying unit includes a second thread unit to be screwed together with the lead screw and applies a preload between the first thread unit and the second thread unit.

17. The drive device used in a head-up display device according to claim 16, wherein the concave mirror irradiates a windshield of a vehicle with display light.

18. The drive device used in a head-up display device according to claim 16, wherein
the support unit includes an elastic support unit configured to urge the mirror holder, and a fixed support unit provided to face the elastic support unit in a movement direction of the movable member and configured to support the mirror holder urged by the elastic support unit,
a first nut member provided separately from the main body unit is provided, and a second nut member including the second thread unit, and an urging member provided between the first nut member and the second nut member and configured to apply a preload between the first thread unit and the second thread unit are provided,
a nut arrangement unit in which the first nut member and the second nut member are arranged is formed in the main body unit,
the first nut member and the second nut member are arranged in the nut arrangement unit in a state where rotation with respect to the main body unit is restricted,
a driving force receiving unit configured to receive a driving force of the drive unit from the first nut member is formed in the nut arrangement unit, and
the first nut member is applied with a preload from the urging member via the driving force receiving unit.

19. The drive device used in a head-up display device according to claim 18, comprising a frame configured to rotatably support the lead screw on one side of the frame, where the drive unit is fixed on a different side of the frame, wherein
the fixed support unit is on the different side of the movable member.

20. The drive device used in a head-up display device according to claim 19, wherein the mirror holder pivots in a state of always contacting with the fixed support unit.

21. The drive device used in a head-up display device according to claim 20, wherein
the first nut member and the fixed support unit are fixed to the movable member, and
the first nut member and the fixed support unit are arranged at substantially the same position in an axis direction of the lead screw.

22. A head-up display device, comprising:
a housing;
a concave mirror configured to reflect display light from a display device housed in the housing;
a mirror holder housed in the housing, rotatably attached to the housing and configured to support the concave mirror; and
a drive device housed in the housing and configured to adjust a position of the mirror holder to adjust an angle of the concave mirror, wherein
the drive device includes a drive unit, a lead screw rotationally driven by the drive unit, and a movable member being moved by a driving force of the drive unit,
the movable member includes a main body unit, a driving force transmitting unit configured to transmit a driving force of the drive unit to the main body unit, a preload applying unit provided separately from the main body unit, and a support unit configured to pivotably support the mirror holder,
the driving force transmitting unit includes a first thread unit to be screwed together with the lead screw and moves the main body unit in an axis direction of the lead screw with a rotation of the lead screw, and
the preload applying unit includes a second thread unit to be screwed together with the lead screw and applies a preload between the first thread unit and the second thread unit.

23. The head-up display device according to claim 22, wherein
the support unit includes an elastic support unit configured to urge the mirror holder,
a fixed support unit provided to face the elastic support unit in a movement direction of the movable member, and configured to support the mirror holder urged by the elastic support unit,
a first nut member provided separately from the main body unit is provided, and a second nut member including the second thread unit, and an urging member provided between the first nut member and the second nut member and configured to apply a preload between the first thread unit and the second thread unit are provided,
a nut arrangement unit in which the first nut member and the second nut member are arranged is formed in the main body unit,
the first nut member and the second nut member are arranged in the nut arrangement unit in a state where rotation with respect to the main body unit is restricted,
a driving force receiving unit configured to receive a driving force of the drive unit from the first nut member is formed in the nut arrangement unit, and
the first nut member is applied with a preload from the urging member via the driving force receiving unit.

24. The head-up display device according to claim 23, comprising a frame configured to rotatably support the lead screw on one side of the frame, where the drive unit is fixed on a different side of the frame, wherein
the fixed support unit is on the different side of the movable member.

25. The head-up display device according to claim 24, wherein
the drive device includes a switch unit configured to detect a position, and
the switch unit detects a position by coming in contact with the fixed support unit.

26. The head-up display device according to claim 25, wherein the mirror holder pivots in a state of always contacting with the fixed support unit.

27. The head-up display device according to claim 26, wherein the first nut member and the fixed support unit are arranged at substantially the same position in an axis direction of the lead screw.

28. The head-up display device according to claim 22, wherein the concave mirror irradiates a windshield of a vehicle with display light.
